(19) United States
(12) Patent Application Publication
(10) Pub. No.: US 2013/0135664 A1
(43) Pub. Date: May 30, 2013

(54) STORAGE OF PROCESSED CONTENT FOR PRINTING

(71) Applicants: Garg Kshitiz, (US); Kashyap Amit, (US)

(72) Inventors: Garg Kshitiz, (US); Kashyap Amit, (US)

(21) Appl. No.: 13/307,166

(22) Filed: Nov. 30, 2011

(51) Int. Cl. G06K 15/02

(52) U.S. Cl. 358/1.15

(57) ABSTRACT

In one embodiment, a command to store content at a persistent memory location is receive at a first computer system from a second computer system. The storage command was sent by the second system responsive to a directive from a user, and the location was identified to the user as a location for storage of printable content. The content is obtained, and stored in a raster processed format at the location. A command to print the processed content is received. The processed content is sent to a network-connected printer for printing in response to receipt of the print command.

### BACKGROUND

Certain network-connected printers are configured to send and receive communications and content from a computer system via a network without being connected to a desktop computer, notebook computer, or other host computing device. Such functionality can provide considerable flexibility and efficiencies for a user, as the user may have the ability to download and print content at the printer without the complication of first establishing a connection with a host.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIGS. 1-2 are block diagrams illustrating systems according to various embodiments.

FIG. 3A is an example display illustrating a sending of a storage command in response to a directive from user according to various embodiments.

FIGS. 3B and 4 are example displays illustrating storage of content in a raster processed format at a persistent memory location according to various embodiments.

FIG. 5 is a block diagram illustrating a system according to various embodiments.

FIG. 6 is an example graphic user interface that depicts a persistent memory location for storage of printable content to a user as a workspace.

FIGS. 7-8 are block diagrams illustrating systems according to various embodiments.

FIG. 9 is an example display of an email sent to a network-connected printer with attached printable content.

FIG. 10 is a flow diagram depicting steps taken to implement various embodiments.

The same part numbers designate the same or similar parts throughout the figures.

### DETAILED DESCRIPTION OF EMBODIMENTS

One way that an internet-connected printer can obtain printable content is to obtain the content via the internet from a computer system that hosts a content service (hereinafter a “content service system”). Typically, upon each instance of the content service system receiving a command to send content to the network-connected printer, the content service system in obtains the content, causes raster image processing of the content, and then sends the content to the printer.

There are circumstances, however, in which it will not be convenient or expedient for the content service system to obtain and/or raster process content in response to each received command to send content. For example, a user that frequently sends requests to print certain content at a network-connected printer via the content service system may view duplicative retrieval of content by the content service system and/or duplicative rendering of the content to raster processed format prior to printing as unnecessary and consumptive of time and computer resources. Further, there is the possibility that the source computer system that the content service system obtains the content from becomes temporarily or permanently inaccessible to the content service system. Similarly, the source computer system may be accessible to the content service system, but no longer hosts the content. These situations can negatively affect the user experience regarding network-connected printers and content service systems when printing repetitive print jobs.

Accordingly, various embodiments described herein were developed to provide a method and a system for storage of processed content for rapid printing. In an embodiment, a content service system receives from a second computer system a command to store content at a persistent memory location. The storage command is a command that was sent by the second system responsive to a directive from a user, and the persistent memory location was identified to the user as a location for storage of printable content. The content service system obtains the content, and stores the content in raster processed format at the location. The content service system receives a command to print the processed content, and responsive to the print command sends the processed content to a network-connected printer for printing. Such storage of printable content at the direction of a user, in anticipation of receipt of a print request, promotes rapid, trouble-free printing of the content and thereby enhances the user experience with respect to printing via a network-connected printer and content service system.

As used herein, a “content service system” refers to a computer system configured to receive a print command from another computer system, and in response to the print command obtain printable content and send the content to a network-connected printer. A “content-source computer system” refers to a computer system that hosts printable content. A “network-connected printer” refers to a printer that is connected to a network, to be capable of obtaining content, sending and receiving messages, accessing network content, and/or accessing applications via a network. In examples, the network may be a proprietary network, a secured network, an open network, an intranet, an extranet, an internet or the Internet. “Content” refers to any text, image, or other information that can be received by and stored at computer system for later display, printing, or other presentation to a user. “Printer” or “printing device” refers to any electronic device that prints and includes multifunctional electronic devices that perform additional functions such as scanning and/or copying. A “persistent memory location” refers to any non-volatile storage medium and may be in the form of, but is not limited to, read-only memory (ROM), flash memory, hard drive memory, or optical disc storage. “Rendering”, “raster processing”, and “rasterizing” of content refers to processing of content to a format that can be understood and/or better understood by a printer. “Rendering”, “raster processing”, and “rasterizing” are used synonymously in this application.

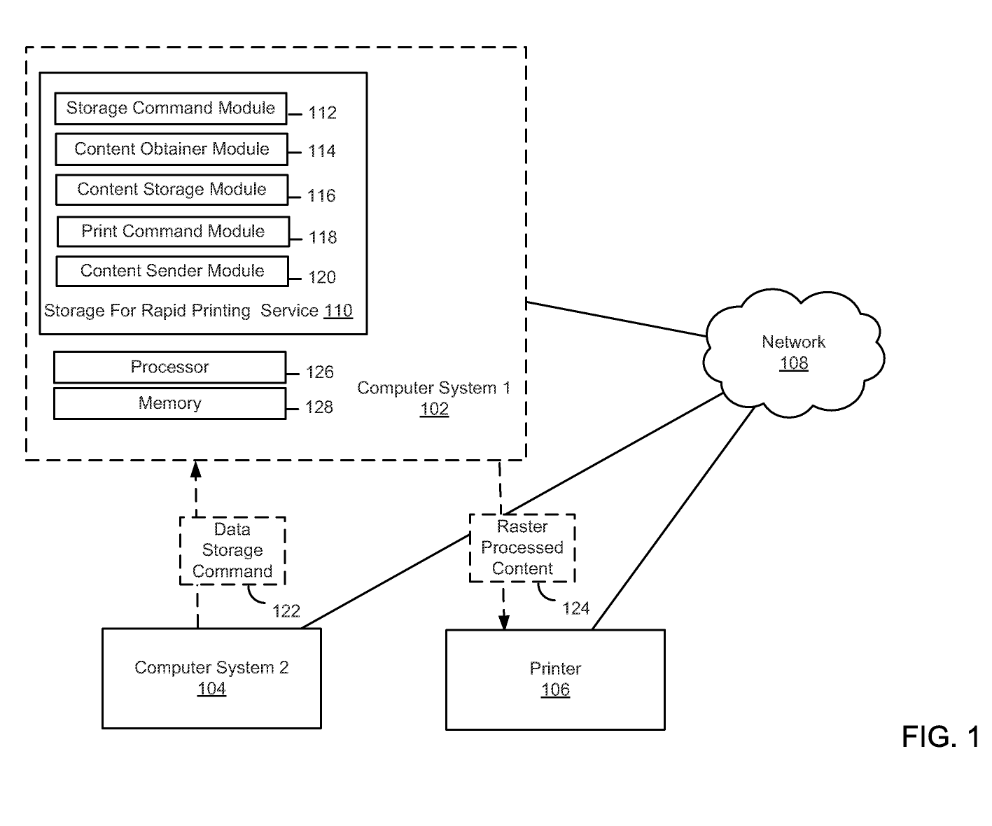

FIG. 1 is a block diagram illustrating such a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 1 shows a first computer system 102, a second computer system 104, and a printer 106 connected to a network 108. First computer system 102 represents generally any computing device or group of computing devices configured to of send network requests and content to, and otherwise communicating with second computer system 104. In embodiments, first computer system 102 may be or include a server, desktop computer, notebook computer, mobile device, tablet computer, and/or any other computing device. Second computer system 104 represents generally any computing device or group of computing devices configured to send network requests and content to, and otherwise communicate with first computer system 102 and printer 106. In embodiments, second computer system 104 may be or include a server, desktop computer, notebook computer, mobile device, tablet computer, and/or any other computing device. Printer 106 represents generally a computing device that is operable to produce printed content, and additionally operable to send network requests and content to, receive network requests and content from, and otherwise communicate with first computer system 102 over network 108.

Network 108 represents generally hardware components and computers interconnected by communications channels that allow sharing of resources and information. Network 108 may include one or more of a cable, wireless, fiber optic, or remote connection via a telecommunication link, an infrared link, a radio frequency link, or any other connectors or systems that provide electronic communication. Network 108 may include, at least in part, an Intranet, the internet, or a combination of both. Network 108 may also include intermediate proxies, routers, switches, load balancers, and the like. The paths followed by network 108 between first computer system 102, second computer system 104, and printer 106 as depicted in FIG. 1 represent the logical communication paths between these devices, not necessarily the physical paths between the devices.

Computer system 102 is shown to include a storage for rapid printing service (“SFRP service”) 110. SFRP service 110 represents generally any combination of hardware and programming configured to enable storage of processed content in anticipation of a print request, thereby facilitating rapid printing of the content at a network-connected printer. SFRP service 110 includes a storage command module 112, content obtainer module 114, content storage module 116, print command module 118, and content sender module 120.

In an example, storage command module 112 receives from second computer system 104 a storage command 122 to store content at a persistent memory location. The storage command is a command that was sent by the second system 104 to first computer system 102 responsive to a directive from a user. The persistent memory location is a memory location that was identified to the user as a location for storage of printable content.

Responsive to receipt of the storage command at computer system 102, content obtainer module 114 obtains the printable content. In an example, content obtainer module 114 obtains the printable content in an already raster processed format. In another example, content obtainer module obtains the printable content in a format that has not undergone raster image processing, and the SFRP service 110 additionally causes raster processed formatting of the content. In examples, the printable content may be obtained from second computer system 104, or from a third computer system. In examples, the content may be obtained via an email received at the first system 102 from the second 104 or the third computer system. Content storage module 116 causes storage of the content in raster processed format at the persistent memory location that was identified to the user. In an example, storage may be configured such that a latest version of particular content, e.g., a .pdf document, is stored by overwriting any prior version of the .pdf document. Alternatively, storage may be configured such that multiple versions of a particular document are stored so as to be available for later version-specific retrieval.

Following the storage event, print command module 118 receives a command to print the processed content. Responsive to receipt of the command at computing device 102, content sender module 120 sends the processed content 124 to printer 106 for printing.

In one embodiment, SFRP service 110 receives from second computer system 104, or from another computing device, a browse request sent at the direction of a user. The browse request is a request for first computer system 102 to enable the user to browse, via the second or other computing device, processed content that is stored at the persistent memory location. In response to the browse request, SFRP service 110 sends to the other computing system a view of at least a portion of the processed content stored at the persistent memory location. In this embodiment, the print command received at first computer system 102 may be a command sent as a result of user interaction with the view.

In another example, the print command that is received is a command to print a plurality of copies of the content at the network-connected printer 106 during a single printing event. In another example, the print command that is received is a command to print a plurality of copies of the content at the network-connected printer 106 spread over a plurality of distinct printing events. As a result of the storage of the content at the persistent memory location in anticipation of the print request, the plurality of copies can be printed at printer 106 during the single printing event, or spread over the plurality of distinct printing events, without duplicative rendering of the content.

The functions and operations described with respect to SFRP service 110 and first computer system 102 may be implemented as a computer-readable storage medium containing instructions executed by a processor (e.g., processor 126) and stored in a memory (e.g., memory 128). In a given implementation, processor 126 may represent multiple processors, and memory 128 may represent multiple memories. Processor 126 represents generally any instruction execution system, such as a computer/processor based system or an ASIC (Application Specific Integrated Circuit), a computer, or other system that can fetch or obtain instructions or logic stored in memory 128 and execute the instructions or logic contained therein. Memory 128 represents generally any memory configured to store program instructions and other data.

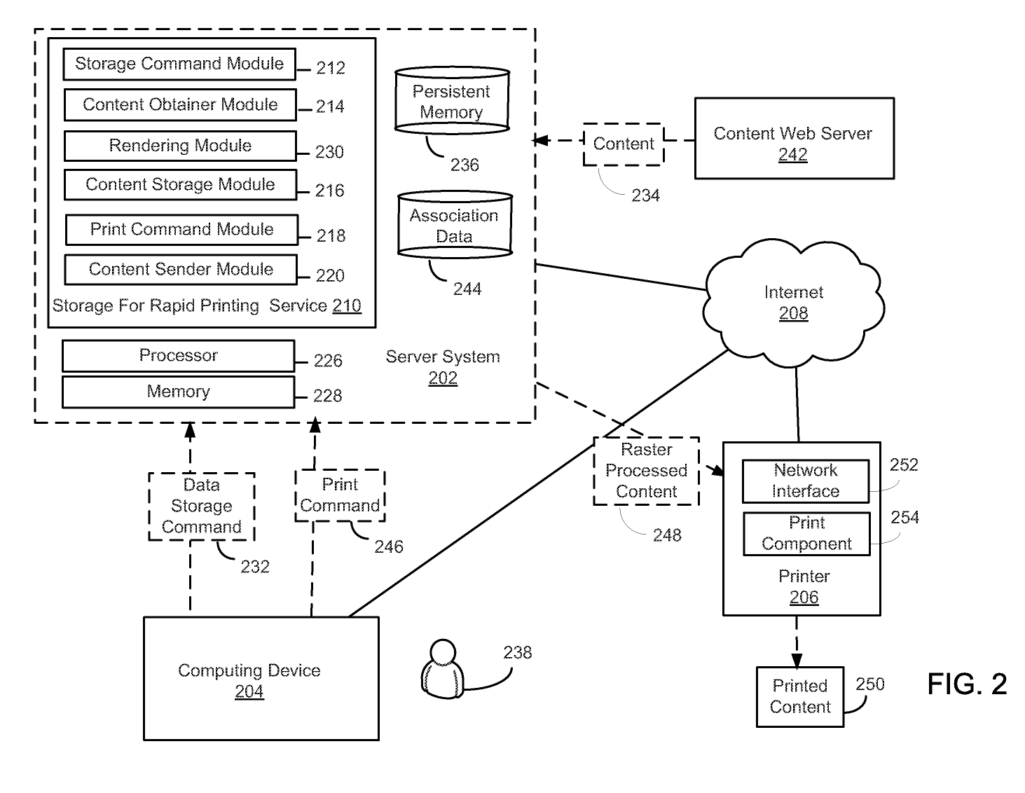

FIG. 2 is a block diagram that includes a server system 202 according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 2 shows a server system 202, a computing device 204, an internet-connected printer 206, and a content web server 242 connected to an internet 208. Computing device 204 represents generally any computing device or group of computing devices configured to send internet requests and content to, and otherwise communicate with server system 202.

Printer 206 is shown to include a network interface 252 and a print component 254. Network interface 252 represents generally any combination of hardware and programming configured for electronically connecting printer 206 to internet 208. Print component 254 represents generally any combination of hardware and programming configured to produce printed content.

Server system 202 represents generally any computing device or group of computing devices configured to accept, process, store and output data according to programmed instructions, and to send Internet requests and content to, and otherwise communicate with computing device 204, printer 206, and content web server 242. As illustrated in FIG. 2, server system 202 may be a single physical device or it may be distributed among multiple physical devices connected over a network (e.g., the Internet). For example, server system 202 may represent a cloud computing infrastructure (i.e., the cloud). In a cloud computing infrastructure, various components/modules of server system 202 may share resources and/or act in concert even though they might be in different physical locations and/or operating on different physical devices.

Internet 208 represents generally any one or more of an internet, the Internet, or an intranet. The paths followed by internet 208 between server system 202, computing device 204, and printer 206 as depicted in FIG. 2 represent the logical communication paths between these devices, not necessarily the physical paths between the devices.

Server system 202 is shown to include a storage for rapid printing service (“SFRP service”) 210. SFRP service 210 represents generally any combination of hardware and programming configured to enable storage of processed content in anticipation of a print request, thereby facilitating rapid printing of the content at an internet-connected printer. SFRP service 210 includes a storage command module 212, content obtainer module 214, rendering module 230, content storage module 216, print command module 218, and content sender module 220.

In the example of FIG. 2, storage command module 212 receives from computing device 204 a storage command 232 to store content 234 at a persistent memory location 236. The storage command 232 is a command that is sent by computing device 204 to server system 202 responsive to a directive from a user 238 of computing device 204. The persistent memory location 236 is a memory location that was identified to user 238 as a location for storage of printable content. In this embodiment, persistent memory location 236 is a hard drive storage apparatus included within server system 202. In other embodiments, the persistent memory location may include read-only memory (ROM), flash memory, optical disc storage, or other non-volatile storage means. In other embodiments, the persistent memory location may be included within a computing system or device other than server system 202, e.g. included within another computer system that is connected to server system 202 via internet 208.

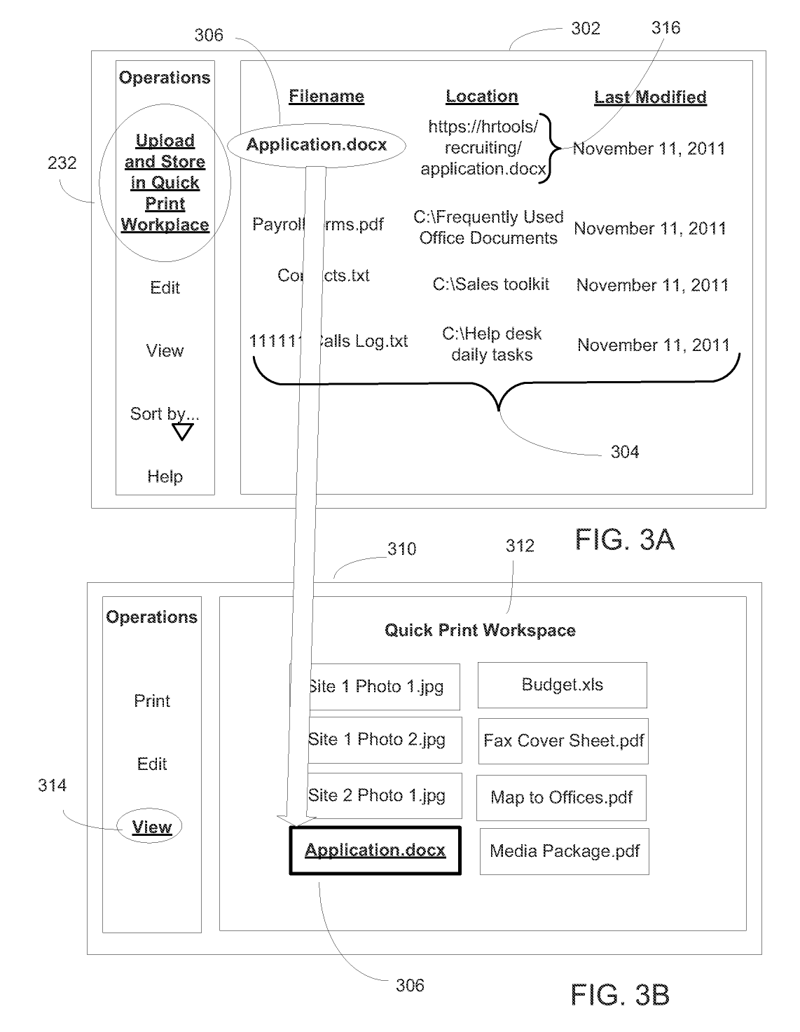

FIG. 3A, in view of FIG. 2, provides an example of sending of a storage command from computing device 204 to server system 202 in response to a directive from user 238. In this example, computing device 204 presents to user 238, via a monitor, touchscreen, or other display device at computing device 204, a first display 302 including a listing 304 of content available for upload to a persistent memory location 236 identified to the user 238 as a “Quick Print Workplace”. Some of the content that is available for upload to the persistent storage location 236, e.g., “PayrollForms.pdf”, “Contacts.txt”, and “111111 Calls Log.txt”, is stored at computing device's 204 “C:” hard drive. Other content, e.g., “Application.docx” 306, is stored at a content web server 242 distinct from server system 202, and is accessible to server 202 over internet 208 via URL “https://hrtools/recruiting/application.docx” 316. In this example, user 238 selects content “Application.docx” 306 via a mouseclick, touch, or other user interface interaction with the first display 302 presented at computing device 204 and shown at FIG. 3A. User 238 also selects and sends a data storage command 232 to “Upload and Store” the content 224 in the “Quick Print Workplace” persistent memory location 236. It should be noted that in other embodiments, the storage command 232 may be sent to, and received by, computing device 204 by other means, e.g., via an email communication.

Returning to FIG. 2, responsive to receipt of storage command 232 at server system 202, content obtainer module 214 obtains the printable content 234 from content web server 242. In this example, the content 234 is obtained in a format that requires rendering prior printing at printer 206. Rendering module 230 causes rendering of the content 234 to a raster processed format. In an example, the rendering to a raster processed format includes utilizing vector digital instructions as to how the content is to be printed to create a high resolution raster or bitmap image of the content. The instructions may be expressed in a number of various languages and formats, including but not limited to HPGL/2 (Hewlett-Packard Graphics Language 2), PostScript, PDF (Portable Document Format), JPEG (Joint Photographic Experts Group standard), TIFF (Tagged Image File Format), PCL3 (Printer Command Language 3) and PCL 6 (Printer Command Language 6). In examples, the rendering may apply smoothing or interpolation algorithms to an input bitmap of the content to generate an output bitmap image. Following completion of rendering of the content 234, content storage module 216 causes the content 234 to be stored in the raster processed format at the persistent memory location 236.

In an embodiment, the rendering module 230 accesses an association database to determine a specified raster processing format compatible with specifications for the printer 206. Association database 244 represents generally any combination of hardware and programming configured to store data associating printers with other computing devices and/or users of other computing devices. In one example association database 244 lists printer 206 as a printer associated with computing device 204 and/or user 238, and lists raster formats that are compatible with the listed printer 206. After receiving a command to print content from computing device 204 and/or user 238, SFRP service 210 renders the content to a raster format that the association database 244 indicates is compatible with printer 206.

FIG. 3B, in view of FIG. 2, is an example display illustrating storage of content in a raster processed format at a persistent memory location. In this example, as a result of user 238 interaction with the “Application.docx” 306 and “Upload and Store in Quick Print Workplace” command 232 icons in the first display 302 shown at FIG. 3A, the “Application.docx” content is caused to be stored at the Quick Print Workspace persistent memory location 312 shown in the second display 310.

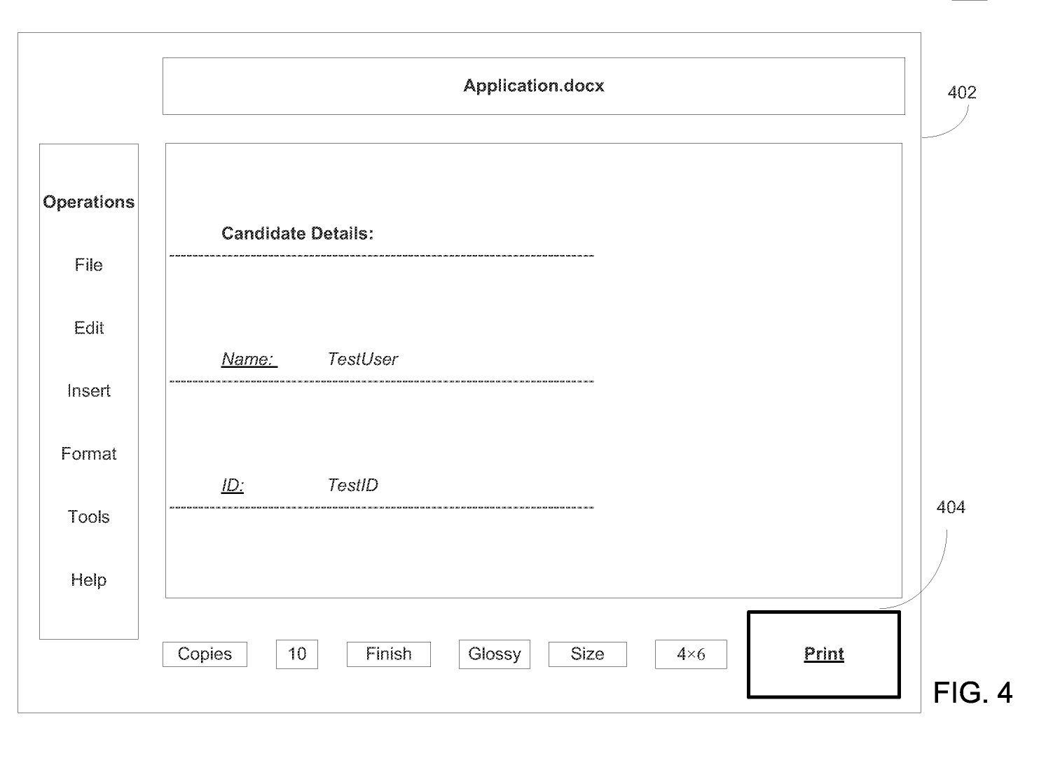

At some point in time following the storage of content 234 in raster processed format at persistent memory location 236, print command module 218 receives a command 246 to print the stored raster processed content. In an example, as a result of user 238 interaction with the “View” icon 314 in the second display 310 shown at FIG. 3B, a view of the “Application.docx” content is caused as illustrated in FIG. 4. The view 402 includes a “Print” command icon 404. The print command 246 may be sent by computing device 204 to server system 202 as a result of such user 238 interaction with the “Print” command icon 404. Returning to FIG. 2, responsive to receipt of print command 246 at server system 202, content sender module 220 sends the raster processed content 248 to printer 206 for printing to produce printed content 250.

SFRP service 210's receipt from computing device 204 of a storage command 232 to store content 234, obtaining of printable content 234 from content web server 242, receipt of a print command from content web server 242, and/or sending of raster processed content 248 to printer 206 may be via a networking protocol, including but not limited to Transmission Control Protocol/Internet Protocol ('TCP/IP″), HyperText Transfer Protocol (“HTTP”), Simple Mail Transfer Protocol (“SMTP”), Extensible Messaging and Presence Protocol (“XMPP”) and/or Session Initiation Protocol (“SIP”).

The functions and operations described with respect to SFRP service 210 and first computer system 204 may be implemented as a computer-readable storage medium containing instructions executed by a processor (e.g., processor 226) and stored in a memory (e.g., memory 228). In a given implementation, processor 226 may represent multiple processors, and memory 228 may represent multiple memories.

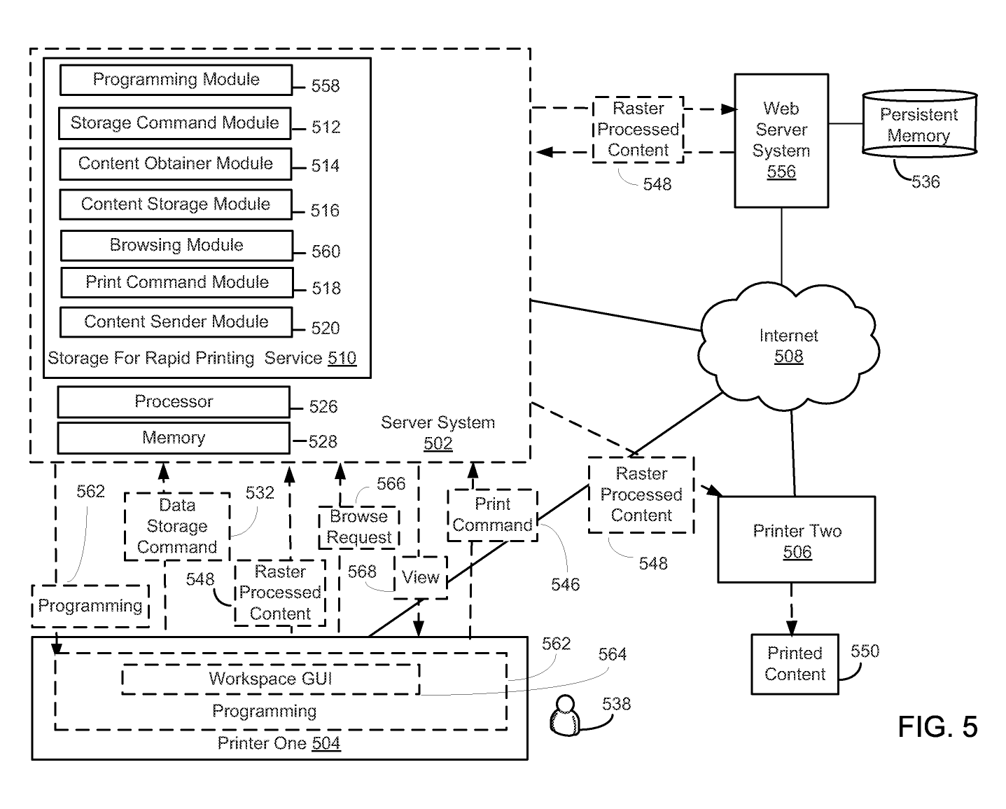

FIG. 5 is a block diagram that includes a server system 502 according to various embodiments. FIG. 5 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 5 shows a server system 502, a first printer 504, a second printer 506, and a web server system 556 connected to an internet 508. First and second printers 504 and 506 represent generally any computing devices configured to communicate with server system 502 and to produce printed content. Web server system 556 represents generally any computing device or group of computing devices configured to send internet requests and content to, and otherwise communicate with server system 502 via internet 508.

Server system 502 represents generally any computing device or group of computing devices configured to accept, process, store and output data according to programmed instructions, and to send internet requests and content to, and otherwise communicate with computing device 504, printer 506, and web server system 556. As illustrated in FIG. 5, server system 502 may be a single physical device or it may be distributed among multiple physical devices connected over a network (e.g., the Internet). For example, server system 502 may represent a cloud computing infrastructure (i.e., the cloud). In a cloud computing infrastructure, various components/modules of server system 502 may share resources and/or act in concert even though they might be in different physical locations and/or operating on different physical devices.

Internet 508 represents generally any one or more of an internet, the Internet, or an intranet. The paths followed by internet 508 between server system 502, first printer 504, second printer 506, and web server system 556 as depicted in FIG. 5 represent the logical communication paths between these devices, not necessarily the physical paths between the devices.

Server system 502 is shown to include a storage for rapid printing service (“SFRP service”) 510. SFRP service 510 represents generally any combination of hardware and programming configured to facilitate rapid printing of the content at an internet-connected printer by providing for storage of processed content in anticipation of a print request. SFRP service 510 includes a programming module 558, storage command module 512, content obtainer module 514, content storage module 516, browsing module 560, print command module 518, and content sender module 520.

In the example of FIG. 5, programming module 558 sends to first printer 504 code or programming 562 that, when executed, enables user 538 of printer 504 to direct the sending of commands to store printable content in rendered form at persistent memory 536. The programming 562, when executed, additionally enables user 538 of printer 504 to direct the sending of commands to cause printing of the at least a portion of the content at the second printer 506.

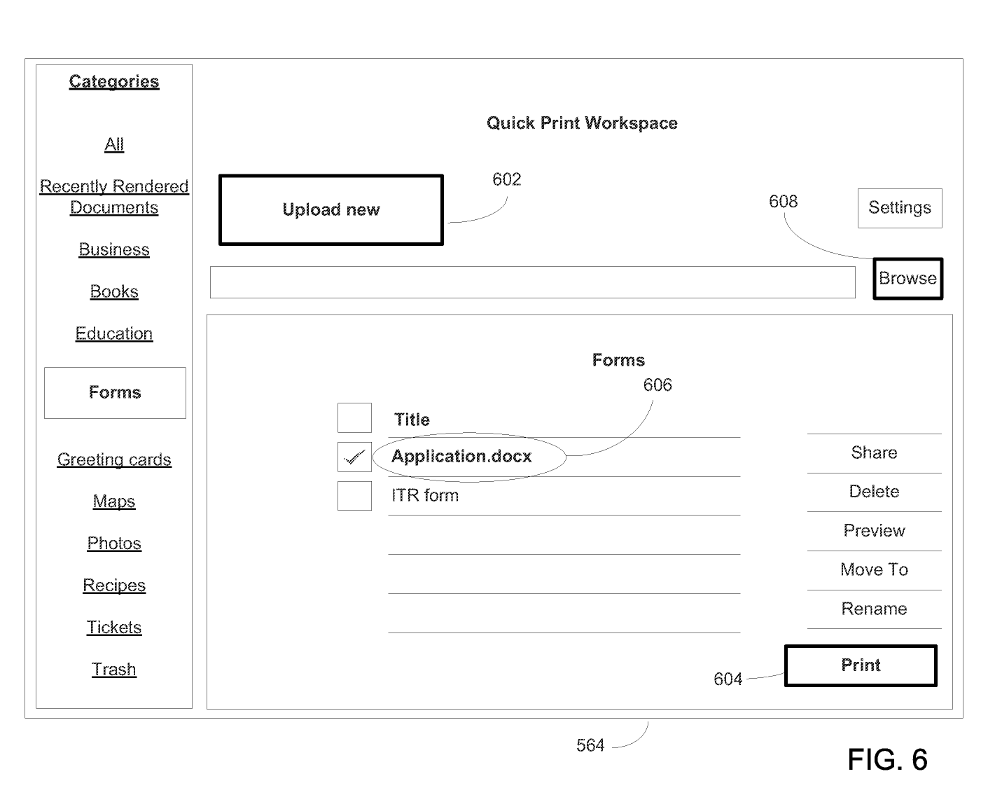

In an embodiment, the programming 562 includes a “Workspace GUI” graphic user interface that simulates the storage location as a desktop, tabletop, file folder system or other workspace for a user. Moving to FIG. 6, in view of FIG. 5, an example of such a graphic user interface is the “Quick Print Workspace” 564 of FIG. 6. The “Upload New” button 602, when interacted with by a user, acts as a command to store printable content in rendered form at persistent memory location 536. The “Print” button 604, when interacted with by a user, acts as a command to print the “Application.docx” content stored at the persistent memory location 536 (FIG. 5). In the example illustrated by FIG. 6 in view of FIG. 2, the content stored at persistent memory location 536 includes a document named “Application.docx” 606.

Returning to FIG. 5, storage command module 512 receives from first printer 504 a storage command 532 to store raster processed content 548 at a persistent memory location 536. The storage command 532 is a command that was sent by first printer 504 to server system 502 responsive to a directive from a user 538 of internet-connected first printer 504. The directive was sent by user 538 as a result of the user's interaction with the “upload new” button 602 of the “Quick Print Workspace” GUI 564 illustrated in FIG. 6. The persistent memory location 536 is a memory location that was identified to the user 538 as a location for storage of printable content. In this embodiment, persistent memory location 536 is a storage location external to server system 502. Persistent memory location 536 is connected to web server system 556. Server system 502 can send content to (for storage), and obtain content from, persistent memory location 536 by sending network requests and other communications to web server system 556 over internet 508.

Responsive to receipt of storage command 532 at server system 502, content obtainer module 514 obtains the printable content 548 from network-connected first printer 504. In this example, the content 548 is sent to server system 502 in a raster processed format that can be understood by second printer 506, so rendering is not required at server system 502. Content storage module 516 then causes, through network communications with web server system 556, the content 548 to be stored in raster processed format, at the persistent memory location 536.

At some time following the storage of content 548 in raster processed format at persistent memory location 536, browsing module 560 receives a browse request 566 from network-connected first printer 504. The browse request 566 is a request sent at the direction of user 538's interaction with the “Browse” button 608 of the Quick Space Workspace 564. In response to the receipt of the browse request 566, browsing module 560 sends a view 568 of at least a portion of the raster processed content 548 that is stored at persistent memory 536 to first printer 504. In an example, the view 568 that is sent may be, or be similar to, the view of the Application.docx content that is illustrated in FIG. 4.

User 538, interacting with the view 568 displayed at first printer 504 via a mouseclick, touch, key pad, or other user interface interaction, sends a print command 546 to print the raster processed content 548 that is stored at server system 502. Print command module 518 at server system 502 receives the print command 546. Responsive to receipt of the print command 546 at server system 502, content sender module 520 obtains the raster processed content 548 from persistent memory 536, via network communication with web server system 556. Content send module 520 then sends the raster processed content 548 to second printer 506 for printing to produce printed content 550.

SFRP service 510's sending of programming 562, receiving of a data storage command 532, receiving of raster processed content 548, receiving of a browse request 566, sending of a view 568, receiving of a print command 546, retrieving content 548 from web server system 556, storing raster processed content 548, and/or sending of raster processed content 548 to second printer 506 may be via a networking protocol. Possible networking protocols include, but are not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”).

The functions and operations described with respect to SFRP service 510 and server system 502 may be implemented as a computer-readable storage medium containing instructions executed by a processor (e.g., processor 526) and stored in a memory (e.g., memory 528). In a given implementation, processor 526 may represent multiple processors, and memory 528 may represent multiple memories.

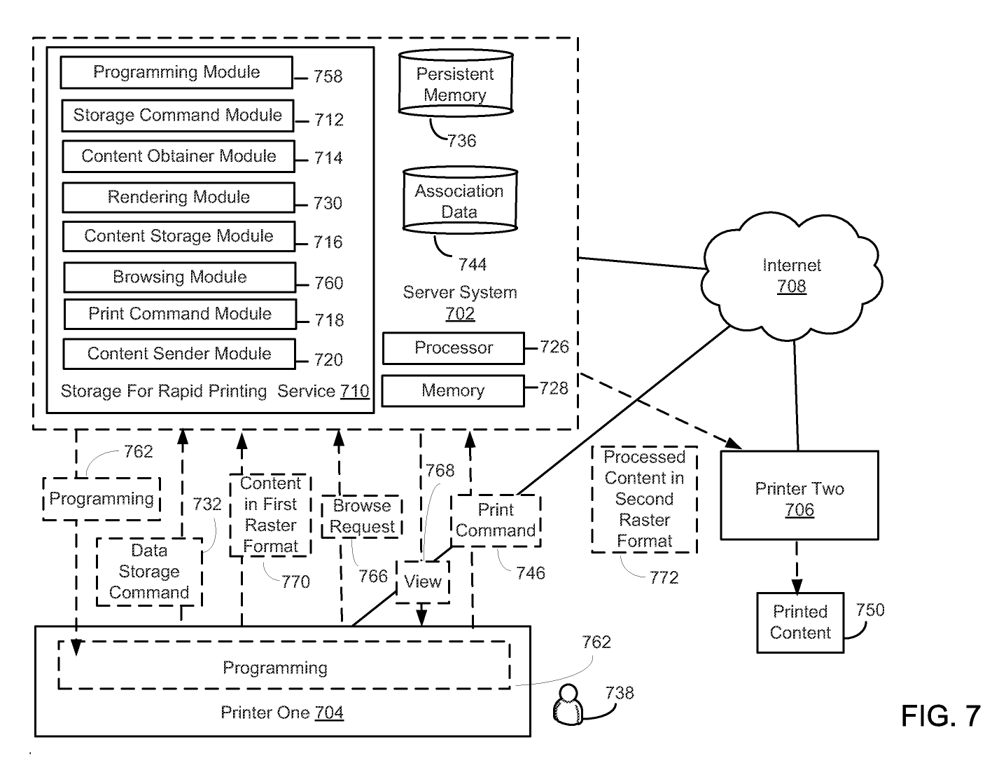

FIG. 7 is a block diagram that includes a server system 702 according to various embodiments. FIG. 7 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 7 shows a server system 702, a first printer 704, and a second printer 706 connected to an internet 708. First and second printers 704 and 706 represent generally any computing devices configured to communicate with server system 702 and to produce printed content. Server system 702 represents generally any computing device or group of computing devices configured to accept, process, store and output data according to programmed instructions, and to send internet requests and content to, and otherwise communicate with computing device 704 and printer 706.

Internet 708 represents generally any one or more of an internet, the Internet, or an intranet. The paths followed by internet 708 between server system 702, first printer 704 and second printer 706 as depicted in FIG. 7 represent the logical communication paths between these devices, not necessarily the physical paths between the devices.

Server system 702 is shown to include a storage for rapid printing service (“SFRP service”) 710. SFRP service 710 represents generally any combination of hardware and programming configured to allow a user to direct storage of processed content at a persistent memory location in anticipation of a print request, and thereby facilitate rapid printing of the content at an internet-connected printer. SFRP service 710 includes a programming module 758, storage command module 712, content obtainer module 714, rendering module 730, content storage module 716, browsing module 760, print command module 718, and content sender module 720.

In the example of FIG. 7, programming module 758 sends to first printer 704 code or programming 762 that, when executed, enables user 738 of printer 704 to direct the sending of commands to store printable content in rendered form at persistent memory 736. Programming module 758 additionally enables user 738 to direct the sending of commands to cause printing of the at least a portion of the content at the second printer 706.

Storage command module 712 receives from first printer 704, via the programming 762, a storage command 732 to store content 770 that is in a first raster processed format at a persistent memory location 736. The storage command 732 is a command that was sent by first printer 704 to server system 702 responsive to a directive from a user 738 of internet-connected first printer 704. The persistent memory location 736 is a memory location that was identified to the user 738 as a location for storage of printable content. In this embodiment, persistent memory location 736 is a storage location included within server system 702.

Responsive to receipt of storage command 732 at server system 702, content obtainer module 714 obtains the printable content 770 from network-connected first printer 704. In this example, the content 770 is sent to server system 702 in a first raster processed format that can be understood by first printer 704, but which cannot be understood by, or is suboptimal for use with, second printer 706. Accordingly, rendering module 730 causes rendering of the content 770 to a second raster processed format that is compatible with second printer 706 to facilitate future rapid printing at second printer 706. In an example, the rendering from a first raster processed format to a second raster processed format might be from a PCL 6 (Printer Command Language 6 format to a PostScript format. Following completion of rendering of the content 770, content storage module 716 causes the content to be stored in the second raster processed format at persistent memory location 736. In an embodiment, the rendering module 730 accesses an association database 744 to determine the second raster processing format that is compatible with specifications for the second printer 706. Content storage module 716 causes the processed content to be stored in the second raster processed format at the persistent memory location 736.

Browsing module 760 receives a browse request 766 from network-connected first printer 704. In response to the receipt of the browse request 766, browsing module 760 sends a view 768 of at least a portion of the raster processed content that is stored at persistent memory 736 to first printer 704. User 738, interacting with the view 768 displayed at first printer 704 via a mouseclick, touch, key pad, or other user interface interaction, sends a print command 746 to print the raster processed content that is stored at persistent memory 736 in second raster format.

Print command module 718 at server system 702 receives the print command 746. Responsive to receipt of the print command 746 at server system 702, content sender module 720 obtains the raster processed content in second raster format from persistent memory 736. Content sender module 720 then sends the content 772 in second raster format to second printer 706 for printing to produce printed content 750.

The functions and operations described with respect to SFRP service 710 and first printer 704 may be implemented as a computer-readable storage medium containing instructions executed by a processor (e.g., processor 726) and stored in a memory (e.g., memory 728). In a given implementation, processor 726 may represent multiple processors, and memory 728 may represent multiple memories.

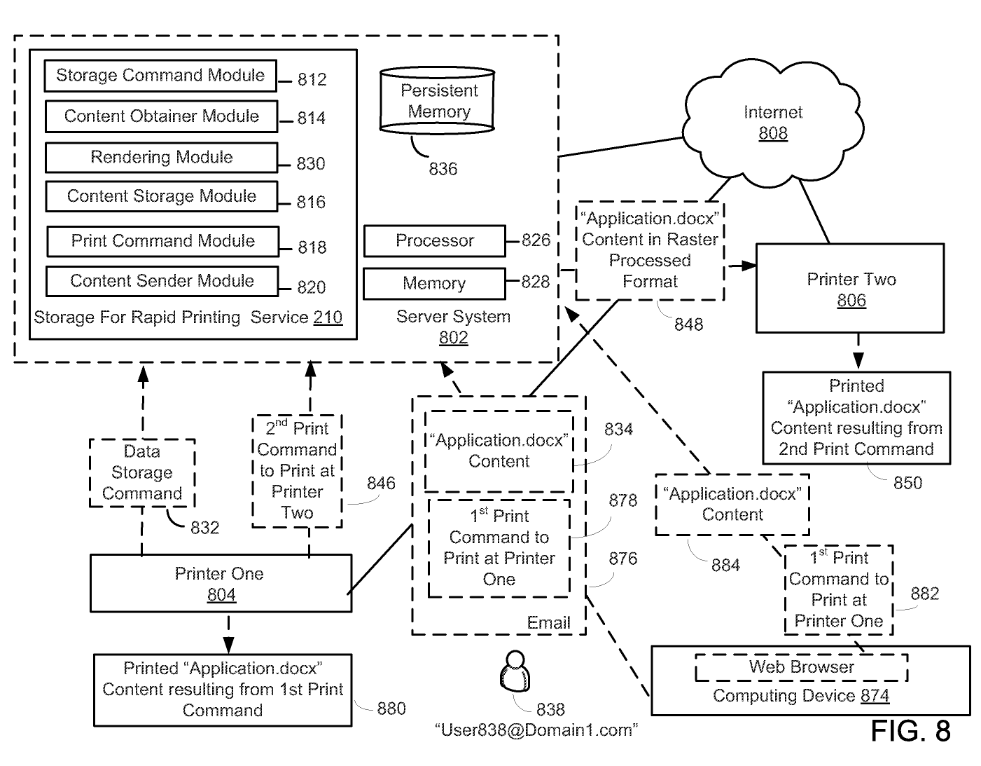

FIG. 8 is a block diagram that includes a server system 802 according to various embodiments. FIG. 8 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 8 shows a server system 802, a first printer 804, a second printer 806, and a computing device 874 connected to an internet 808. First and second printers 804 and 806 represent generally any computing devices configured to communicate with server system 802 and to produce printed content. Computing device 874 represents generally any computing device or group of computing devices configured to send printable content and print commands to server system 802 via an email sent over internet 808. Server system 802 represents generally any computing device or group of computing devices configured to accept, process, store and output data according to programmed instructions, to send internet requests and content to, and otherwise communicate with first printer 804, second printer 806, and to receive internet requests and email communications from computing device 874. Internet 808 represents generally any one or more of an internet, the Internet, or an intranet. The paths followed by internet 808 between server system 802, first printer 804, second printer 806, and computing device 874 as depicted in FIG. 8 represent the logical communication paths between these devices, not necessarily the physical paths between the devices.

Server system 802 is shown to include a storage for rapid printing service (“SFRP service”) 810. SFRP service 810 represents generally any combination of hardware and programming configured to enable storage of processed content in anticipation of a print request, thereby facilitating rapid printing of the content at an internet-connected printer. SFRP service 810 includes a storage command module 812, content obtainer module 814, rendering module 830, content storage module 816, print command module 818, and content sender module 820.

In the example of FIG. 8, storage command module 812 receives from first printer 804, at the direction of user 838, a storage command 832. In this example, storage command 832 is a command to store at persistent memory location 836 all printable content that is attached to emails received at server system 802 from email address “User838@Domain1.com” (an email address associated with user 838).

Server system 802 receives an email 876 sent by user 838. The email 876 includes as an attachment to the email content 834 “Application.docx”. The email 876 additionally includes a first print command 878, which when interpreted by server system 802 causes server system 802 to send the “Application.docx” content 834 to first printer 804 for first printing. First printer 804 prints the “Application.docx” content 804 to create printed content 880.

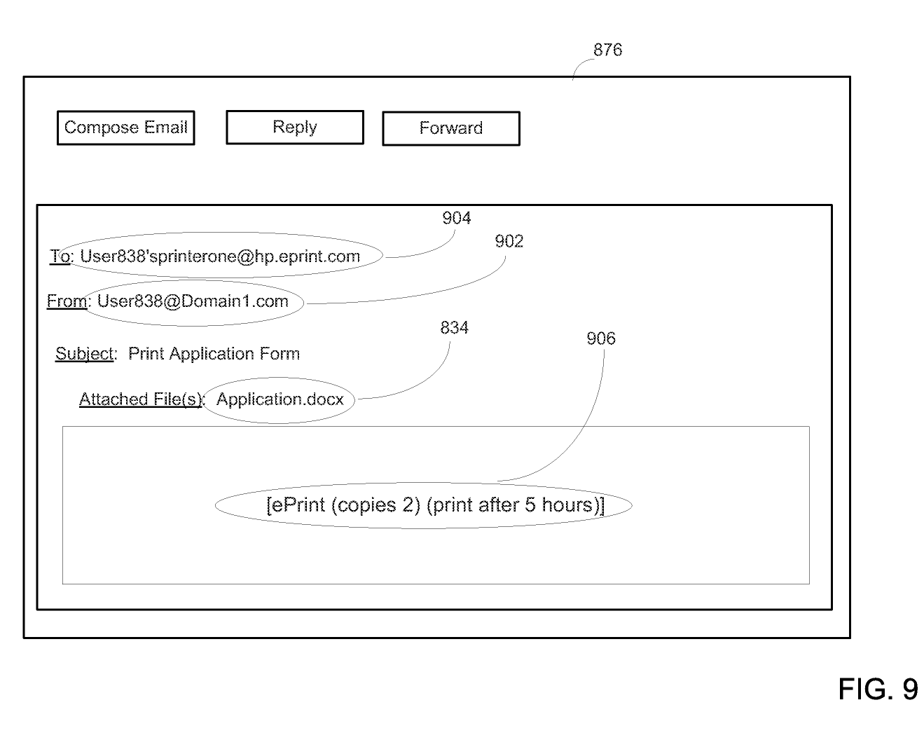

FIG. 9, in view of FIG. 8, provides an example display of email 876. The email 876 is sent by user 838 from computing device 874 utilizing email address “User838@Domain1.com” 902. The recipient email address 904 “User838'sprinterone@hp.eprint.com” identifies first printer 804 as the destination printer at which the Application.docx content 834 is to be printed. Email 876 received from computing device 874 contains a print command 906 “[ePrint(copies 2) (print after 5 hours)]” to cause server system 802 to send content 834 to first printer 804 for first printing. In this example, according to print command 906, two copies of Application.docx content are to be printed at first printer 804 after a five hour waiting period following server system 802's receipt of email 876. After the waiting period, server system 802 sends the content 834 to first printer 804. First printer 804 in turn prints “Application.docx” content to produce first printed content 880.

In this example, content 834 is obtained, via the email 876 from computing device 874, in a format that requires rendering prior printing at printer 806. Rendering module 830 causes rendering of the content 834 to a raster processed format such as PostScript, PDF (Portable Document Format), JPEG (Joint Photographic Experts Group standard), TIFF (Tagged Image File Format), PCL3 (Printer Command Language 3), or PCL 6 (Printer Command Language 6). Following rendering of the content, content storage module 816 causes the content 834 to be stored in the raster processed format at the persistent memory location 836 included within server system 802.

At some point following server system 802's receipt of email 876 and the rendering and storage of the “Application.docx” content, print command module 818 receives a second print command 846. In the example depicted in FIG. 8, the second print command 846 is sent from first printer 804 at the direction of user 838 via interaction with a user interface at first printer 804. Responsive to receipt of the second print command 846 at server system 802, content sender module 820 retrieves from persistent memory location 836 the “Application.docx” content in raster format. Content sender module 820 then sends the “Application.docx” content in its raster format 848 to second printer 806 for printing. Second printer 806 prints the content 848 to produce printed content 850.

It should be noted that while in the example of FIGS. 8 and 9 the storage command was a general command to store all at the persistent memory location 836 all content received from email address “User838'sprinterone@hp.eprint.com”, in other embodiments, storage commands may be received individually with respect to specific content. In another example, an individual command to store the Application.docx content 848 at the persistent memory location 836 may be embedded in the print command 906 of FIG. 9. For instance, a storage command such as “(store quick print workspace)” or “(store qpw”) may be added or embedded into to the “[ePrint(copies 2) (print after 5 hours)]” print command 906 included in email 876 to create a content-specific storage command.

It should be further noted that while in the example of FIGS. 8 and 9 the first print command was included within a received email communication 876, and the second print command 846 is sent from first printer 804 at the direction of user 838, other possibilities exist. In other embodiments the first (or second) print commands may be received via other communication means or protocols. Such other communication means or protocols may include, but are not limited to. Short Message Service (“SMS”), Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”). For instance in another embodiment the first print command and attached content “Application.docx” might be received at server system 802 as a result of user 838 interaction with a print button GUI at a portal or website accessible via a browser at computing device 874.

The functions and operations described with respect to SFRP service 810 and first printer 804 may be implemented as a computer-readable storage medium containing instructions executed by a processor (e.g., processor 826) and stored in a memory (e.g., memory 828). In a given implementation, processor 826 may represent multiple processors, and memory 828 may represent multiple memories.

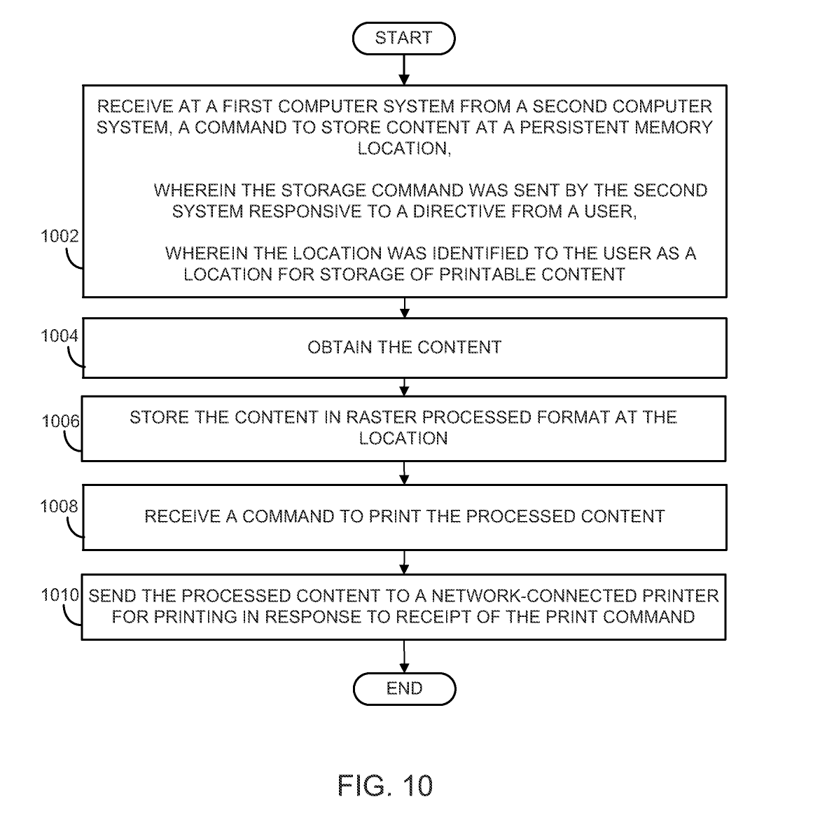

FIG. 10 is a flow diagram of operation in a system according to various embodiments. In discussing FIG. 10, reference may be made to the diagrams of FIGS. 1, 2, 5, 7 and 8 to provide contextual examples. Implementation, however, is not limited to those examples. Starting with FIG. 10, a command to store content at a persistent memory location is received at a first computer system from a second computer system. The storage command was sent by the second system responsive to a directive from a user. The location was identified to the user as a location for storage of printable content (block 1002). Referring back to FIGS. 1, 2, 5, 7 and 8, storage command module 112, 212, 512, 712, or 812 may be responsible for implementing block 1002.

Continuing with the flow diagram of FIG. 10, the content is obtained (block 1004). Referring back to FIGS. 1, 2, 5, 7 and 8, content obtainer module 114, 214, 514, 714, or 814 may be responsible for implementing block 1004.

Continuing with the flow diagram of FIG. 10, the content is stored in raster processed format at the location (block 1006). Referring back to FIGS. 1, 2, 5, 7 and 8, content storage module 116, 216, 516, 716, or 816 may be responsible for implementing block 1006.

Continuing with the flow diagram of FIG. 10, a command to print the processed content is received (block 1008). Referring back to FIGS. 1, 2, 5, 7 and 8, print command module 118, 218, 518, 718, or 818 may be responsible for implementing block 1008.

Continuing with the flow diagram of FIG. 10, the processed content is sent to a network-connected printer for printing in response to receipt of the print command (block 1010). Referring back to FIGS. 1, 2, 5, 7 and 8, content sender module 120, 220, 520, 720, or 820 may be responsible for implementing block 1010.

Although the flow diagram of FIG. 10 shows specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

Various modifications may be made to the disclosed embodiments and implementations without departing from their scope. Therefore, the illustrations and examples herein should be construed in an illustrative, and not a restrictive, sense.

What is claimed is:

1. A computer-readable storage medium containing instructions for storage of processed content for printing, the instructions when executed by a processor causing the processor to:
receive at a first computer system from a second computer system a command to store content at a persistent memory location,
wherein the storage command was sent by the second system responsive to a directive from a user,
wherein the location was identified to the user as a location for storage of printable content;
obtain the content;
store the content in raster processed format at the location;
receive a command to print the processed content; and
send the processed content to a network-connected printer for printing in response to receipt of the print command.

2. The medium of claim 1, wherein the instructions cause the processor to provide to the second system programming to enable a user to direct the sending of the storage command.

3. The medium of claim 2, wherein the programming includes a user interface that simulates the location as a workspace for a user.

4. The medium of claim 2, further comprising rendering the content to raster processed format.

5. The medium of claim 2, further comprising accessing an association database to determine a specified raster processing format compatible with specifications for the printer, and wherein the content is rendered to and stored in the specified format.

6. The medium of claim 2, wherein the programming enables a user to direct the sending of the print command.

7. The medium of claim 1, wherein the content is obtained from the second system.

8. The medium of claim 1, wherein the content is obtained via the network from a computer system other than the second system.

9. The medium of claim 1, wherein the content is obtained via an email received at the first system.

10. The medium of claim 1, wherein the storage command is received via an email received at the first system.

11. The medium of claim 1, wherein the print command is a second print command, and obtaining the content includes receiving the content via a communication that includes a first print command.

12. The medium of claim 11, wherein the communication is an email communication.

13. The medium of claim 1, wherein the print command is for printing of a plurality of copies of the content, and the plurality of copies are printed without duplicative rendering of the content.

14. The medium of claim 1, wherein the second system is a network-connected printer.

15. A system for storage of processed content for printing, comprising:
a storage command module, configured to receive at a first computer system from a second computer system a command to store content at a persistent memory location,
wherein the storage command was sent by the second system responsive to a directive from a user,
wherein the location was identified to the user as a location for storage of printable content;
a content obtainer module, configured to obtain the content;
a content storage module, configured to store the content in raster processed format at the location;
a print command module, configured to receive a command to print the processed content; and
a content sender module, configured to send the processed content to a network-connected printer for printing in response to receipt of the print command.

16. The system of claim 15, further comprising a rendering module configured to render the content to raster processed format.

17. The system of claim 16,
wherein the format is a first format and the printer is a first printer, and
wherein the rendering module is additionally configured to render the content to a second raster processed format and store the content in the second format at the location to facilitate future printing at a second network-connected printer.

18. The system of claim 15, further comprising a browsing module configured to
receive a request to browse among the stored processed content, and
send a view of at least a portion of the stored processed content in response to receipt of the browse request.

19. The system of claim 15, further comprising a programming module configured to provide to the second system programming to enable a user to direct the sending of the storage command and the print command.

20. A computer-readable storage medium containing instructions for storage of processed content for printing, the instructions when executed by a processor causing the processor to:
provide, from a first computer system to a second computer system, programming that
includes a user interface depicting a persistent memory location as a user workspace, and
enables a user to direct sending of commands to store and print content;
receive at the first computer system from the second computer system, via the programming, a command to store content at the persistent memory location,
wherein the storage command was sent by the second system responsive to a directive from a user,
wherein the location was identified to the user as a location for storage of printable content;
obtain the content;
render the content to raster processed format;
store the content in raster processed format at the location;
receive from the second system, via the programming, a request to browse among the stored processed content;
send to the second system a view of at least a portion of the stored processed content in response to receipt of the browse request;
receive from the second system a command to print a portion of the processed content selected by a user during browsing; and
send the portion to a network-connected printer for printing in response to receipt of the print command.
